(19) United States
(12) Patent Application Publication
(10) Pub. No.: US 2005/0278317 A1
(43) Pub. Date: Dec. 15, 2005

(54) Personalized search engine

(76) Inventors: William Gross, Pasadena, CA (US); Tom McGovern, Pasadena, CA (US); Steve Colwell, Santa Barbara, CA (US)

Correspondence Address: CHRISTIE, PARKER & HALE, LLP, PO BOX 7068, PASADENA, CA, 91109-7068, US

(21) Appl. No.: 11/130,629

(22) Filed: May 16, 2005

Related U.S. Application Data
(60) Provisional application No. 60/571,452, filed on May 14, 2004.

(51) Int. Cl. G06F 7/00

(52) U.S. Cl. 707/3

(57) ABSTRACT

A system and method and method for personalized searching of a computer network, such as a local area network or the world wide web, is disclosed. The method involves submitting a user search query, submitting the search query and a user profile to a search engine, processing the search query based on a user profile to calculate the relevancy of search results, and returning highly personalized search results to the user based upon the calculated relevancy. The user profile may include declared and observed information. Declared information includes information provided by the user, such as, for example, individual and demographic information. Observed information is gathered by the system by reviewing user word usage gathered from the user's documents, machine configuration, e-mail and instant messages, and other areas. The system may compare words to a baseline to determine the relative incidence of word usage for inclusion into the user's profile. Observed information may further or alternatively include information regarding the user's historical behavior, including the types and frequency of websites visited.

### CROSS-REFERENCE TO RELATED APPLICATION

This application claims the benefit of U.S. Provisional Application No. 60/571,452, filed May 14, 2004, the disclosure of which is hereby incorporated by reference.

### FIELD OF THE INVENTION

The present invention relates generally to an information retrieval application, and more specifically to a search engine for searching information on computer networks based on a combination of the user's query and information the user provides or the device discerns about the user.

### BACKGROUND

There are many search engines capable of searching computer networks for documents of interest, and generating a list of relevant documents (“search results”) based on the search engine's determination of relationships between the user's query and characteristics of the documents. Such search engines typically present the search results by sorting the results based on the search engines' determination of relevance of a document to the query. As such, the results are inherently limited by the specific terms provided by the user and the user's ability to accurately construct the query such that the terms specify the user's intent.

### BRIEF DESCRIPTION OF THE DRAWINGS

Exemplary embodiments of the personalized search engine disclosed herein are illustrated in the accompanying drawings, which are for illustrative purposes only. The drawings comprise the following figures, in which:

FIG. 1 is a flowchart illustrating the operation of an exemplary search process whereby the search engine utilizes the user's personalized profile, or digital signature, to determine relevance of documents;

FIG. 2 is a flowchart illustrating the creation of the digital signature based on information declared by and observed of the user;

FIG. 3 is a schematic diagram illustrating the components of the exemplary personalized search application capable of using the apparatus of FIG. 1;

FIG. 4 is a schematic diagram illustrating select information that would be stored in the personal signature of the user;

FIG. 5 is a schematic diagram illustrating the processing of the search query and post-processing results based on the signature; and

FIG. 6 is a schematic diagram illustrating the processing of the search query together with the signature to provide the user search results.

### DETAILED DESCRIPTION OF THE INVENTION

Throughout the following description, the term “computer network” is used to refer to a system of interconnected devices, including without limitation, user-accessible server sites, peer to peer networks, the Internet as well as intranets and local area networks. Further, the term “site” is used to refer to server sites that implement current or future World Wide Web standards for the coding and transmission of hypertext documents. These standards currently include HTML (the Hypertext Markup Language), HTTP (the Hypertext Transfer Protocol), and asynchronous protocols. It should be understood that the term “site” is not intended to imply a single geographic location, as a web or other network site can, for example, include multiple geographically distributed computer systems that are appropriately linked together. Furthermore, while the following description relates to an embodiment utilizing the Internet and related protocols, other networks or hypermedia databases, such as networked interactive televisions, and other present or future protocols may be used as well. For example, for use with cell phones, personal digital assistants (PDAs), and the like, HDML (Handheld Device Markup Language), WAP (Wireless Application Protocol), WML (wireless markup language), XML (Extensible Markup Language), or the like can be used.

Additionally, unless otherwise indicated, the functions described herein are performed by programs including executable code or instructions running on one or more network-enabled devices, including, without limitation, general-purpose computers, cellular phones, PDAs, and other present or future devices. The devices may include one or more central processing units for executing program code, volatile memory, such as random access memory (RAM) for temporarily storing data and data structures during program execution, non-volatile memory, such as a hard disk storage or optical storage, for storing programs and data, including databases, and a network interface for accessing an intranet and/or the Internet. However, the functions described herein may also be implemented using special purpose computers, state machines, and/or hardwired electronic circuits. The exemplary processes described herein do not necessarily have to be performed in the described sequence, and not all states have to be reached or performed.

As used herein, the term “search engine” is defined broadly, and includes, in addition to its ordinary meaning, a local or remote information retrieval system whereby users and/or electronic agents formulate and submit a query and the system locates documents that relate to the information contained in the query. The processing of those queries and identification of the related documents may occur in a number of ways including the use of an index, such as an inverted file structure, signature files or any other present or future manner to retrieve information. The index is typically developed through computerized agents that access the world wide web through a process known as crawling and spidering.

As used herein, the term “query” is defined broadly, and includes, in addition to its ordinary meaning, a user's or agent's submission of terms to a search engine. Formation of the query may occur in a number of manners including, without limitation, exact or lexical, Boolean, natural language, or any other present or future manner.

As used herein, the term “document” is defined broadly, and includes, in addition to its ordinary meaning, any files and data, including without limitation, computer files, machine configurations, executables and websites. The term “document” is not limited to computer files containing text, but also includes computer files containing graphics, audio, video, and other multimedia data.

As used herein, the term “search results” is defined broadly, and includes, in addition to its ordinary meaning, search results based on an index of documents where a computerized algorithm searches through the index and compiles search results based on relevancy to the query. Search results may also include present or future types of paid listings whereby the results have a sponsor, defined broadly, who provides incentives for the search engine to present the listing to the user. Paid listings, includes, in addition to its ordinary meaning, pay for placement, pay for click, pay for action and paid inclusion listings generated by a search engine in response to a user's search query.

As described in greater detail below, an exemplary personalized search apparatus provides a method for providing a search engine additional information about the user and their search query whereby the search engine tailors its processing providing the user providing more relevant search results.

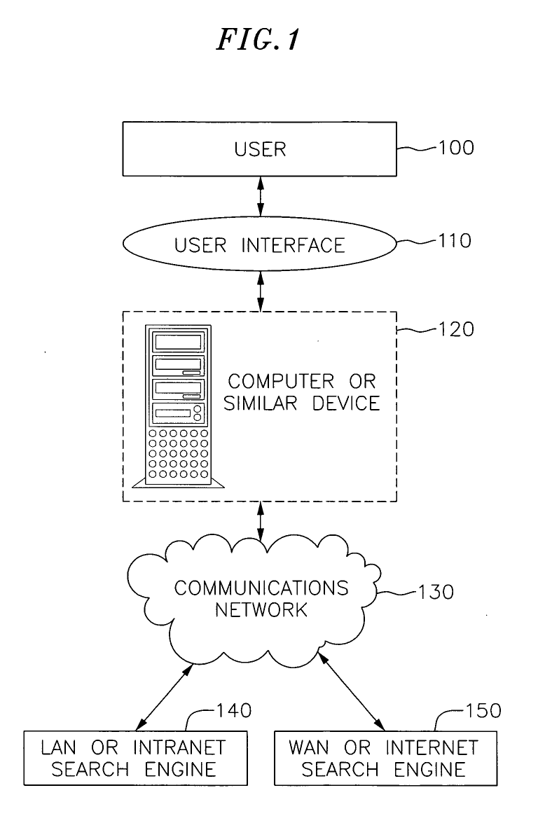

FIG. 1 illustrates an exemplary arrangement where a user 100, through a user interface 110 on a computer or similar device 120, accesses the search engine through a communications network 130 and submit an information search query to either a local intranet search engine 140 or to an Internet search engine 150.

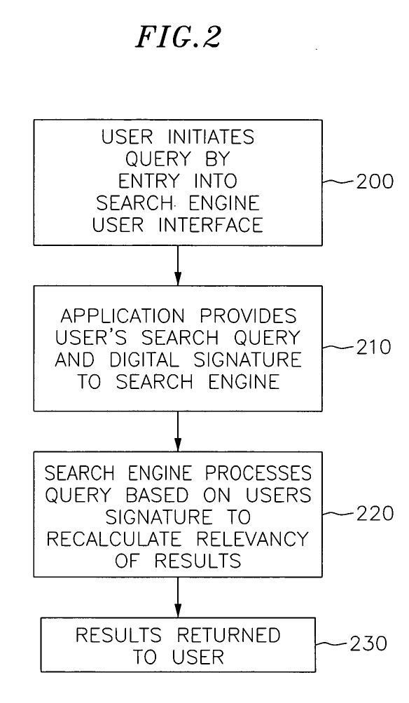

Referring to FIG. 2, the user initiates a query by entry into a search engine user interface 200 for processing of the query and tailoring the search results 210. In one embodiment, the system provides to the search engine, along with the query, a user profile or digital signature. The information in the digital signature allows the query to be contextualized by the user's profile. It also allows a means to weight, or scale, the importance of the terms based on the data contained in the user's files. In this way, the search engine is able to recalculate the relevancy of search results 220, prior to returning the results to the user 230. In another embodiment, the apparatus separately transmits the signature information to the search application, which stores it for future use. In this example, the user identifies himself or herself when submitting queries, either by logging in or other means such as a cookie on their computer, and the search application retrieves the signature from its storage device for processing with the query. In another embodiment, user profile information is maintained locally and filtering or resorting of search results occurs at the client side to protect against any potential unauthorized dissemination of the user's private information.

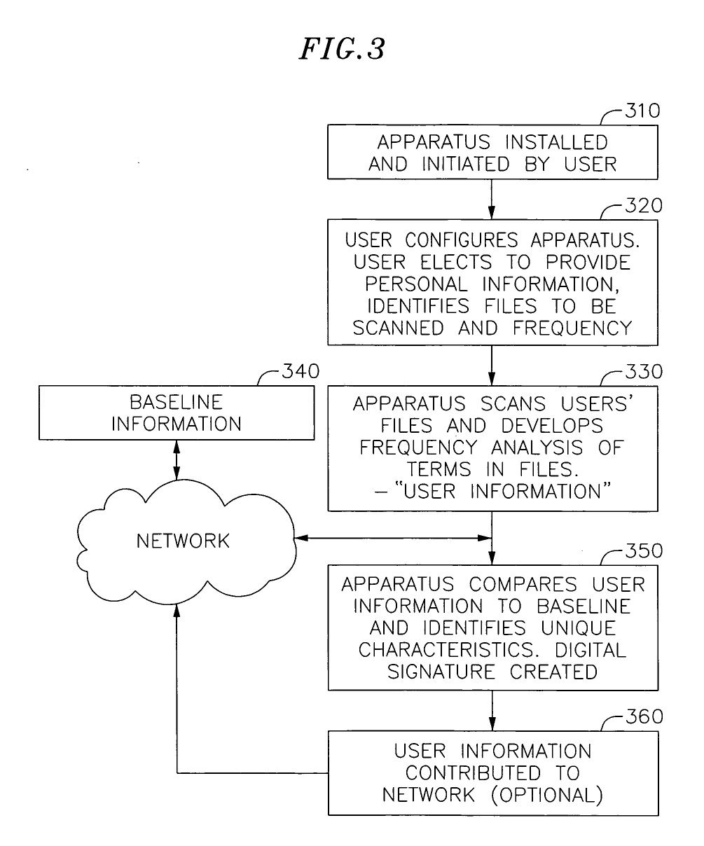

Referring to FIG. 3, in another embodiment, the apparatus provides a technique for executing an electronic agent that forms the profile, or digital signature, of the user using both declared and observed information. In one example, the system is installed or downloaded by the user 310. This agent may be a client on the user's computer or software from a host server that may function as a virtual client. Declared information may include, but is not limited to, personal information declared by the user, such as demographic information and interests. Observed information includes, but is not limited to, an analysis of documents on the user's computer system, previous search history, and previous URL visitation history. The agent uses this information to create all or part of the digital signature of the user. The frequency of update of the digital signature is configurable by the user, or predetermined by the system.

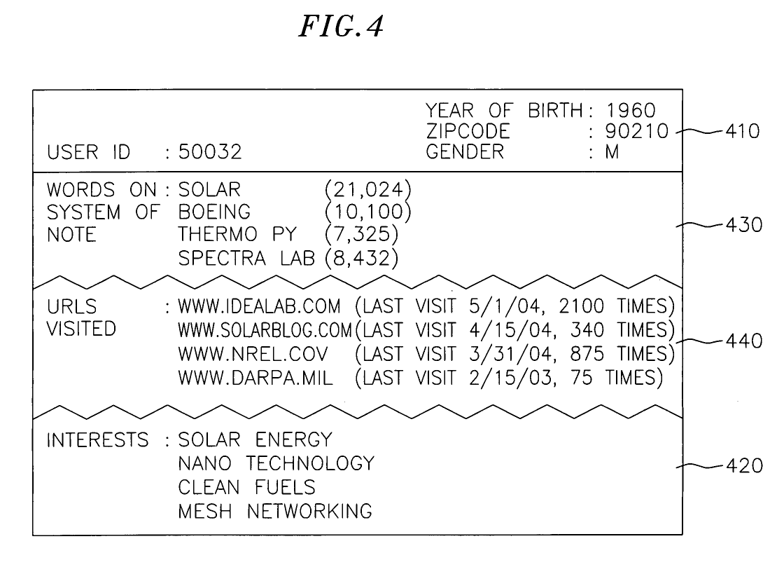

In one embodiment, the user's declared information is provided during the process of installing and configuring the system 320. Referring to FIG. 4, the declared information 410 may include various demographic information such as sex, age, location as well as interests 420 (such as history, wildlife, technology etc.) The declared information is stored for use in the digital signature.

Referring once again to FIG. 3, to obtain observed information, the electronic agent also performs an analysis of information contained in the user's computer 330. This is performed as part of the process of installing the apparatus and is configurable by the user with respect to what data is analyzed and upon what frequency. Examples of the data analyzed includes all system and non-system files such as, but not limited to, machine configuration, e-mail, word processing documents, electronic spreadsheets, presentation and graphic package documents, instant messenger history and stored PDF documents. The agent analyzes the user's data by scanning the words used in the documents and determining which words have a higher incidence of use versus a baseline 340, 350. Referring to FIG. 4, those words, and their semantic meaning, are stored for inclusion in the digital signature 430. For example, if a user has 3000 references to “intel” that would far exceed and average user and would be stored in the baseline as a high incidence word. An example of this observed information in the signature is shown in FIG. 4. For security, compressing and encrypting the signature may be done in several ways based on well known techniques of hashing and keys.

Referring once again to FIG. 3, the system creates the digital signature using the declared and observed information (collectively “user's information”). This signature may be created in multiple ways. In one embodiment, the system compares words used in the user's information to a baseline of the word use in the English, or other, language to identify interests. Further, the system may record the semantic meaning of the word, or context, of the word in the creating the signature. For instance, if the word “jaguar” is often used in the users information in the context of computer operating systems, it will record the word and the context of computers rather than alternative meaning such as automobiles or wildlife. If the user then searched for “jaguar manual” the normal search results of documents for “jaguar manual” are modified such that the computer operating system documents would have a higher than normal relevance ranking and those related to automobiles would have a lower ranking than normal. In another embodiment, the system contributes the user's information to a network that continually updates the baseline word use 340. The system then in turn provides an updated baseline for use in comparison to the user's information and for creation of the digital signature.

In one embodiment, the user may review and edit any information in the user profile to highlight immediate intent. In addition, the user may create multiple profiles, subprofiles or combined profiles. These profiles may be used in conjunction with a particular search to provide context for the search. By way of example, the user may set up different profiles reflecting his or her varying interests or hobbies. By way of another example, if a user is purchasing a gift for his or her elderly aunt, the user may not want to submit his or her user profile for the search, but may instead provide no profile, a new profile or a modified profile setting forth information concerning his or her aunt.

In another embodiment, the user may set the period for observed behavior to coincide with the user's current online session to create a more immediate or time restricted context for the search.

In a further embodiment, the user may toggle the user profile on or off, restrict certain parameters, modify certain parameters, or specify additional parameters for one or more search sessions.

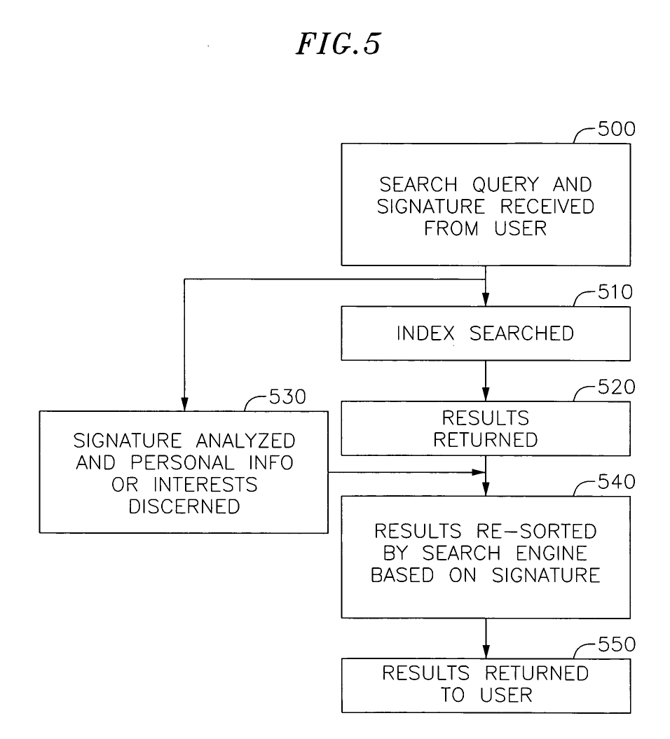

FIG. 5 outlines how, in one embodiment, the search engine processes a query and reformulates the results based on the user's information. The system receives a search query and signature from a user 500. The system then searches an index of documents 510 and returns results 520. The digital signature is analyzed and personal interests and information is discovered 530. The discovered information is used by the search engine to resort the results based on the signature 540. The results are then returned to the user.

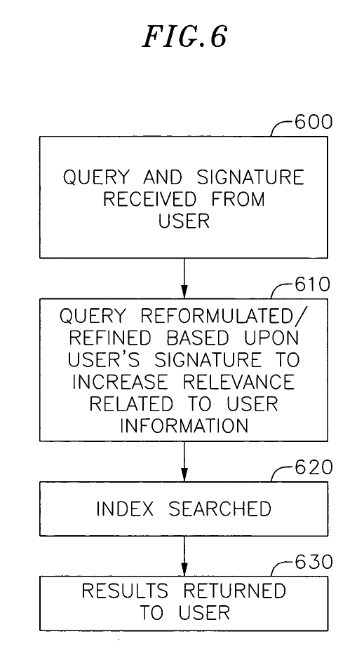

FIG. 6 outlines an alternative embodiment whereby the search engine refines the query by modifying or appending information relevant to the user based on the information in the signature. In this embodiment, the search query and signature are received from the user. The query is then reformulated or refined based on the user's signature to increase the relevance of the query by incorporating information or keywords into the query relating to the user 610. The index is then searched based on the modified or enhanced query 620 and the results are returned 630.

Referring also to FIG. 4, in a modified embodiment, in addition to word frequency usage, a user's prior web browser history, including searches, may be used to improve relevance 440. The personal search apparatus may track, and store a log of, web sites visited, time spent, prior searches and use that data to increase the relevance weighting of sites that have been visited before to improve relevance. This includes recording URL's visited and the number of page views as well as other actions (download, buy etc.) at the URL's. This history is stored for inclusion in the digital signature. For example, if one of the word pairs in the user's corpus user information that has a higher frequency, than the baseline of average frequency, is “pro bikes” because you recently bought a new derailer for your mountain bike, and type in the search term “bike rack’ then the normal search results for “bike rack” would be retrieved from the web (say the top 100 or top 1000) and then the web site of the “pro bikes” company would be increased in relevance than its normal position as you have done business with them before (as indicated by its frequency on your hard disk being significantly higher than normal).

In a modified embodiment, in addition to using the user's signature to influence the results, the search engine compares the signature with other user's signatures identifying others who have similar profiles. In the event that other users have utilized the search engine for the same query (or similar based on synonyms) the relevance rankings of the search results would be re-ranked based on the search history of the previous user(s). For instance, if user “A” searched for “mouse” and iterated their query to “optical mice” and user “B” had a signature that resembles “A” and searched for “mice”, then the search engine would boost the relevance ranking on documents related to optical mice over that of the other meanings of mice (sites on rodents, mice for animal testing etc.) In effect, the signatures based on the user's information forms a means for collaboration between anonymous users.

Access to the search engine may be either direct, such as by a user accessing the engine through a URL on the Internet, or through a distributed fashion via a application contained on users' computers or via a third party web site that provides search services on a syndicated manner for the search engine.

Thus, in contrast to conventional systems, which often fail to list the items most relevant to the user first because of its inability to discern the users intentions or interests, the system disclosed herein enables the user to receive tailored results based upon information contained in the user profile, or digital signature.

While the foregoing detailed description discloses several embodiments of the present invention, it should be understood that this disclosure is illustrative only and is not limiting of the present invention. It should be appreciated that the specific configurations and operations disclosed can differ from those described above, and that the methods described herein can be used in contexts other than use of a personalized search engine.

1. A method for searching a computer network, the method comprising:
generating a user profile;
submitting a user search query;
providing the search query to a search engine;
processing the search query based on the user profile to calculate the relevancy of search results; and
returning the search results to the user based upon the calculated relevancy.

2. The method of claim 1, further comprising:
declaring information relating to user demographics and interests;
observing information relating to the user's behavior; and
processing the declared information and observed information to generate the user profile.

3. The method of claim 2, further comprising:
updating the user profile based on a user-defined frequency.

4. The method of claim 2, wherein the observing step comprises one or more of:
analyzing documents on the user's computer system;
analyzing the user's search history; and
analyzing the user's URL visitation history.

5. The method of claim 4, wherein the analyzing documents step comprises analyzing information contained in one or more documents on a user's network-enabled device.

6. The method of claim 5, further comprising:
scanning words in the documents;
establishing a baseline of user word usage;
determining the relative incidence of words compared to the baseline; and
generating a component of the user profile based on the words identified in the determining step.

7. The method of claim 6, further wherein the baseline is established by reviewing word usage from a group of users.

8. The method of claim 5, further comprising:
scanning words in the documents;
establishing a baseline based on average word usage in the language of the user;
determining the relative incidence of words compared to the baseline; and
generating a component of the user profile based on the words identified in the determining step.

9. The method of claim 2, further comprising the step of setting the period within which information is observed.

10. The method of claim 2, further comprising the step of generating a plurality of profiles for a user.

11. The method of claim 1, further comprising the step of toggling on or off processing of the user profile.

12. The method of claim 1, further comprising the step of modifying the user profile prior to the processing step.

13. The method of claim 1, wherein the step of processing the search query based on the user profile comprises resorting the search results based on information contained within the profile.

14. The method of claim 1, wherein the step of processing the search query based on the user profile comprises modifying the search query submitted to the search engine to perform the search.

15. A system for searching a computer network, the system comprising:
means for generating a user profile;
means for formulating a user search query;
means for providing the search query and a user profile to a search engine;
means for processing the search query based on the user profile to calculate the relevancy of search results; and
means for returning the search results to the user based upon the calculated relevancy.

16. The system of claim 15, further comprising:
means for declaring information relating to user demographics and interests;
means for observing information relating to the user's historical behavior; and
means for processing the declared information and observed information to generate the user profile.

17. The method of claim 16, further comprising:
means for updating the user profile based on user-defined frequency.

18. The method of claim 16, wherein the observing step comprises:
means for analyzing documents on the user's computer system;
means for analyzing the user's previous search history; and
means for analyzing the user's previous internet visitation history.

19. The method of claim 18, wherein the means for analyzing documents comprises means for analyzing information contained in one or more of the user's documents.

20. The method of claim 19, further comprising:
means for scanning words in the documents;
means for establishing a baseline of user word usage;
means for determining the relative incidence of words compared to the baseline; and
means for generating a component of the user profile based on the words identified in the determining step.

21. The method of claim 20, further wherein the baseline is established by reviewing word usage from a group of users.

22. The method of claim 19, further comprising:
means for scanning words in the documents;
means for establishing a baseline based on average word usage in the language of the user;
means for determining the relative incidence of words compared to the baseline; and
means for generating a component of the user profile based on the words identified in the determining step.

23. The system of claim 16, further comprising means for setting the period within which information is observed

24. The system of claim 16, further comprising means for generating a plurality of profiles for a user.

25. The system of claim 15, further comprising means for toggling on or off processing of the user profile.

26. The system of claim 15, further comprising means for modifying the user profile prior to the processing step.

27. The method of claim 15, wherein the means for processing the search query based on the user profile comprises means for resorting the search results based on information contained within the user profile.

28. The method of claim 15, wherein the means for processing the search query based on the user profile comprises means for modifying the search query used by the search engine to perform the search.
